(19) United States
(12) Patent Application Publication
(10) Pub. No.: US 2011/0068131 A1
(43) Pub. Date: Mar. 24, 2011

(54) Dispensing device

(75) Inventors: Rainer Strobel-Schmidt, Bad Woerishofen (DE); Christian Hefele, Breitenbrunn (DE); Hans Peter Lederle, Durach (DE)

(73) Assignee: Hilti Aktiengesellschaft, Schaan (LI)

(21) Appl. No.: 12/924,059

(22) Filed: Sep. 20, 2010

(30) Foreign Application Priority Data
Sep. 21, 2009 (DE) 10 2009 042 023.1

(51) Int. Cl. B05C 17/01

(52) U.S. Cl. 222/391

(57) ABSTRACT

The invention relates to a dispensing device (11) for containers (31) containing a compound, comprising a compartment (12) for the container, a piston rod (13) that can be moved with respect to the compartment (12), an advancing mechanism (21) encompassing two clamping levers (22, 23) that are arranged on the piston rod (13) and that can be pivoted in the lengthwise direction of the piston rod (13), whereby a first clamping lever (22) serves to advance the piston rod (13), while the second clamping lever (23; 63) serves to lock the piston rod (13), and comprising an unlocking device (36) that interacts with the second clamping lever (23) of the advancing mechanism (21) in order to unlock the piston rod (13). The unlocking device (36) has two actuating parts (37) positioned at a distance from each other.

This claims the benefit of German Patent Application No. 10 2009 042 023.1, filed Sep. 21, 2009 and hereby incorporated by reference herein.

The present invention relates to a dispensing device for containers containing a compound.

### BACKGROUND INFORMATION

Such a dispensing device makes it possible for compounds, such as mortar compounds or sealing compounds packaged in containers, to be dispensed at an application place. Containers encompass, for example, cartridges having one or more compartments for one or more components of the compound to be dispensed, which is/are either contained directly in the compartments of the cartridge or else packaged, for example, in a foil pack. The term “container” also encompasses foil packs filled with one or more components of the compound to be dispensed, said foil packs being inserted into a separate holder or into a holder arranged on the dispensing device.

German patent application DE 42 31 418 A1 discloses a dispensing device for containers containing a compound, comprising a compartment for the container, a piston rod that can be moved with respect to the compartment, an advancing mechanism and an unlocking means. The advancing mechanism encompasses two clamping levers that are arranged on the piston rod and that can be pivoted in the lengthwise direction of the piston rod, whereby a first clamping lever serves to advance the piston rod, while the second clamping lever serves to lock the piston rod. The advancing mechanism is arranged in a housing of the dispensing device, said housing having a handle. The handle has a pivoting trigger lever as the actuating element for the advancing mechanism, said trigger lever serving to pivot the first clamping lever. Moreover, on the rear end of the housing, the dispensing device has an unlocking part which serves as the unlocking means for unlocking the piston rod and which interacts with the second clamping lever of the advancing mechanism.

When the trigger lever is actuated, that is to say, when it is pivoted in the direction of the handle, the first clamping lever is pivoted so that it comes into contact with a part of the outer surface of the piston rod and it advances the piston rod by a corresponding value. If the piston rod is to be manually retracted, for instance, in order to remove the container inserted into the compartment or in order to place a new container into the compartment of the dispensing device, the unlocking part is actuated, a process in which the locking of the second clamping lever is undone.

### SUMMARY OF THE INVENTION

The dispensing device of DE 42 31 418 A1 is characterized particularly for its reliability and ease of handling. However, untrained users or users with small hands might have difficulty in holding the dispensing device and unlocking the piston rod at the same time.

One objective of the invention is to create a dispensing device for containers containing a compound which does not entail the above-mentioned disadvantages and especially which allows even better handling of the dispensing device.

According to the invention, the unlocking means has at least two actuating parts positioned at a distance from each other.

Since the unlocking means has two separate actuating parts, the at least one piston rod can be actuated at two different places of the unlocking means. The actuating parts are advantageously provided on the dispensing device in such a way that the unlocking means can be actuated by the user with one hand, without having to grasp around it and without having to use the other hand. Consequently, the other hand is free to push the at least one unlocked piston rod forward or backward. Advantageously, the actuating parts are arranged in such a manner that the unlocking means can be operated by right-handed as well as left-handed people.

Preferably, the actuating parts are arranged on both sides of the at least one piston rod relative to the lengthwise direction of the at least one piston rod, as a result of which it is especially easy for right-handed as well as left-handed people to actuate the unlocking means.

Preferably, a handle is provided for holding the dispensing device, and the actuating parts are arranged adjacent to one side of the handle facing the compartment, as a result of which the unlocking means can advantageously be actuated without having to be gripped by the hand and can be actuated, for instance, with the thumb.

Preferably, the unlocking means comprises an unlocking part that acts on at least the second clamping lever, and the two actuating parts are provided on the unlocking part so that the unlocking means has only a small number of elements. Advantageously, the unlocking part and the actuating parts are configured in one piece.

Preferably, the actuating parts are spring-loaded by at least one spring element, as a result of which, in the non-actuated state, the actuating parts are forced into the preferred position and return automatically to the preferred position after the unlocking means has been actuated. Advantageously, the spring element is a coil spring, especially a helical compression spring. The spring element is advantageously provided on the at least one piston rod.

Preferably, a coupling element is provided for coupling the two clamping levers, and it can be moved along the at least one piston rod by means of the actuating parts, so that, when the unlocking means is actuated, in addition to the second clamping lever, the first clamping lever of the advancing mechanism also pivots, thus simplifying the manual movement of the at least one piston rod. Thanks to the coupling element, the at least one piston rod can also be unlocked when the actuation element of the advancing mechanism has been actuated. Particularly in the case of a dispensing device having a manual advancing mechanism, the dispensing device is easier to handle when the actuating lever of the advancing mechanism has been actuated.

Preferably, the actuating parts can be pivoted by means of at least one pivoting shaft provided on the dispensing device, which ensures that the unlocking means can be easily actuated with just one finger of one hand. Advantageously, the actuating parts are of a length that allows an advantageous force reduction. The joint is advantageously formed by a bearing point or by a bearing shaft provided on the dispensing device, either of which defines the pivoting axis for the pivoting actuating parts. Advantageously, all of the actuating parts of the unlocking means can be pivoted around a joint pivoting axis.

As an alternative, the actuating parts of the unlocking means are moved along a guide link when the unlocking means is actuated, a process in which the appertaining part of the unlocking means acts on at least the second clamping lever. In such an embodiment, the actuating parts can be advantageously moved along a linear and/or curved guide link. Particularly if the actuating parts are of a great length, it can be advantageous to guide the actuating parts along a guide link rather than having a purely pivoting bearing.

In another embodiment, the actuating parts can be configured so that they can be pivoted and concurrently moved on the dispensing device, as a result of which they are easy to actuate and, at the same time, the entire unlocking means can be configured so as to be compact.

Preferably, the actuating parts for unlocking the piston rod can be pivoted in the direction of the compartment of the dispensing device, so that the unlocking means can be easily actuated with one finger, especially with the thumb.

Preferably, a housing is provided which at least partially surrounds the advancing mechanism and on which at least one stop is provided for at least one of the actuating parts. The at least one stop delimits the maximum path of movement that can be traversed by the appertaining actuating part when it is actuated. Advantageously, two stops are provided on the housing for at least one actuating part, said stops delimiting the path of movement of the appertaining actuating part in both directions.

### BRIEF DESCRIPTION OF THE DRAWINGS

The invention will be elaborated upon in greater detail below on the basis of embodiments. The following is shown:

FIG. 1—a dispensing device in a side view;

FIG. 2—a view of the dispensing device along line II-II in FIG. 1;

FIG. 3—a partial section through the dispensing means along line III-III in FIG. 2;

FIG. 4—a partial section analogous to FIG. 3, with the actuating part and the piston rod in the unlocked state; and

FIG. 5—a partial section through a dispensing means analogous to FIG. 3, with an actuating part configured in an alternative manner.

Fundamentally speaking, identical parts are designated by the same reference numerals in the figures.

### DETAILED DESCRIPTION OF THE EMBODIMENTS

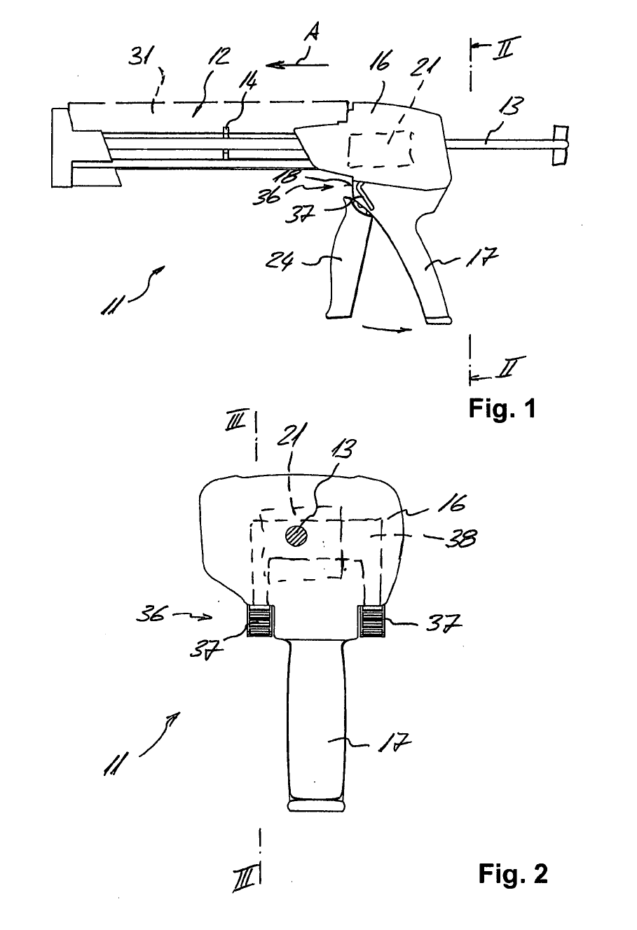

The dispensing device 11 for containers 31 containing a compound shown in FIGS. 1 to 4 comprises a compartment 12 for the container 31, a piston rod 13 that can be moved relative to the compartment 12 and a mechanically actuatable advancing mechanism 21. A pressure piston 14 that acts on the container 12 or on the compound contained in it is provided on the end of the piston rod 13 facing the compartment 12. The compartment 12 is delimited at the front, that is to say, in the dispensing direction A, by a head plate 15 and, at the rear, by a part of a housing 16 through which the piston rod 13 passes. A handle 17 positioned essentially perpendicular to the dispensing direction A protrudes from the housing 16.

The advancing mechanism 21 comprises two clamping levers 22 and 23 that are arranged on the piston rod 13 and that can be pivoted in the lengthwise direction of the piston rod 13. The first clamping lever 22 serves to advance the piston rod 13, and a trigger lever arranged as an actuation element 24 of the advancing mechanism 21 in front of the handle 17 in the direction of the compartment 12 serves to pivot said first clamping lever 22 in the direction of the handle 17 when the advancing mechanism is actuated. The actuation element 24 is operationally connected to the first clamping lever 22 in a familiar manner. The second clamping lever 23 serves to lock the piston rod 13 and prevents the piston rod 13 from being accidentally moved opposite to the dispensing direction A after it has been advanced.

Moreover, the dispensing device 11 has an unlocking means 36 that interacts with the second clamping lever 23 of the advancing mechanism 21 in order to unlock the piston rod 13. The unlocking means 36 has two actuating parts 37 positioned at a distance from each other which, relative to the lengthwise direction of the piston rod 13, are arranged on both sides thereof, adjacent to a side 18 of the handle 17 facing the compartment 12.

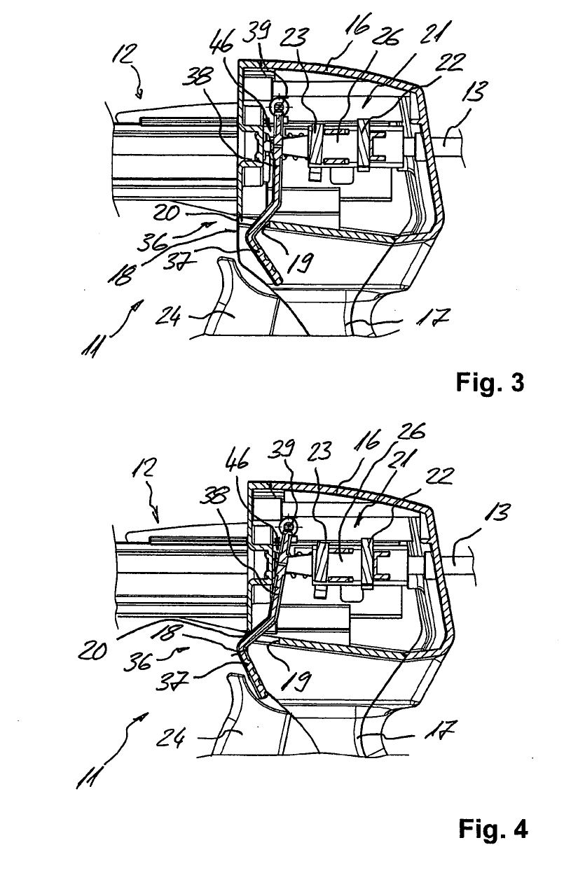

The actuating parts 37 are provided on an unlocking part 38 and are configured so as to form a single part with it. The unlocking part 38 and thus the actuating parts 37 can be pivoted around a shared pivoting shaft 39 (See FIGS. 3 and 4) provided in the housing 16. The actuating parts 37 are spring-loaded opposite to the dispensing direction A by a spring element 46. The spring element 46 is a helical compression spring that is arranged between a part of the housing facing the compartment 12 and the unlocking part 38.

The two clamping levers 22 and 23 are coupled to each other by means of a coupling element 26, whereby the coupling element 26 is additionally connected to the unlocking part 38. The coupling element 26 can be moved along the piston rod 13 by means of the actuating parts 37.

For purposes of unlocking the piston rod 13, for example, in order to switch or replace an empty or partially empty container 31, the actuating parts 37 of the unlocking means 36 are pivoted in the direction of the compartment 12 of the dispensing device 11. In this process, not only the second clamping lever 23 but also the first clamping lever 22 is pivoted by means of the coupling element 26, so that the piston rod 13 is completely unlocked and can thus be easily manually pushed (FIG. 4). After the actuating parts 37 have been relieved, they are forced by the spring element 46 back into the position shown in FIG. 3. In this process, the second clamping lever 23 once again comes into contact with the outside of the piston rod and prevents an undesired movement of the piston rod 13 relative to the compartment 12 of the dispensing device 11. The maximum pivoting path of the actuating parts 37 is delimited by two stops 19 and 20 provided on the housing 16.

When the piston rod 13 is unlocked, the actuation element 24 of the advancing mechanism 21 can continue to be held in a position where it is contact with the handle 17, so that the dispensing device 11 can be reliably handled.

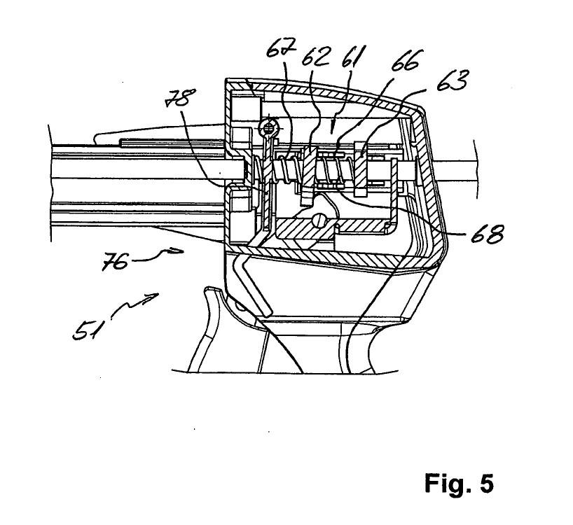

The dispensing device 51 of FIG. 5 differs from the previously explained dispensing device 11 in terms of the configuration of the coupling element 66, which is no longer directly connected to the unlocking part 78 of the unlocking means 76. Via a coil spring arranged as a spring element 67 between the unlocking part 78 and the second clamping lever 63, and via a coil spring arranged as a spring element 68 between the second clamping lever 63 and the first clamping lever 62, the unlocking part 78 acts simultaneously on both clamping levers 62 and 63.

This type of unlocking means is suitable not only for mechanically driven dispensing devices, but also for other dispensing devices that are driven, for instance, electrically or pneumatically.

What is claimed is:

1. A dispensing device for containers containing a compound, comprising:
a compartment for the container;
at least one piston rod movable with respect to the compartment;
an advancing mechanism including a first clamping lever and a second clamping lever both arranged on the piston rod and pivotable in a lengthwise direction of the at least one piston rod, the first clamping lever serving to advance the at least one piston rod, the second clamping lever serving to lock the at least one piston rod; and
at least one unlocking device interacting with the second clamping lever of the advancing mechanism to unlock the at least one piston rod, the unlocking device having at least two actuating parts positioned at a distance from each other.

2. The dispensing device as recited in claim 1 wherein the actuating parts are arranged on both sides of the at least one piston rod relative to the lengthwise direction of the at least one piston rod.

3. The dispensing device as recited in claim 1 further comprising a handle for holding the dispensing device, the actuating parts are arranged adjacent to a side of the handle facing the compartment.

4. The dispensing device as recited in claim 1 wherein the unlocking device includes an unlocking part acting on at least the second clamping lever, the two actuating parts being provided on the unlocking part.

5. The dispensing device as recited in claim 1 wherein the actuating parts are spring-loaded by at least one spring element.

6. The dispensing device as recited in claim 1 further comprising a coupling element for coupling the two clamping levers, the coupling element movable along the at least one piston rod by the actuating parts.

7. The dispensing device as recited in claim 1 further comprising a pivoting shaft, the actuating parts being pivotable by the at least one pivoting shaft.

8. The dispensing device as recited in claim 7 wherein the actuating parts are pivotable in a direction of the compartment to unlock the piston rod.

9. The dispensing device as recited in claim 1 further comprising a housing at least partially surrounding the advancing mechanism, at least one stop being provided on the housing for at least one of the actuating parts.
